(19) United States
(12) Patent Application Publication
(10) Pub. No.: US 2006/0115231 A1
(43) Pub. Date: Jun. 1, 2006

(54) Electro-optic device, and method for manufacturing electro-optic element

(75) Inventor: Kohei Ishida, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/260,751

(22) Filed: Oct. 27, 2005

(30) Foreign Application Priority Data
Nov. 29, 2004 (JP) 2004-343423

(51) Int. Cl. G02B 6/00

(52) U.S. Cl. 385/147

(57) ABSTRACT

A method for manufacturing an electro-optic element including: forming a first electrode and a second electrode on a luminescent layer deposited on a substrate; applying current to the luminescent layer through the first electrode and the second electrode; thereby the luminescent layer emits light; wherein a functional liquid including a conductive material is discharged on the side of the luminescent layer of the first electrode by a droplet discharge device, in order to form a conductive spacer with optical transparency.

### BACKGROUND OF THE INVENTION

1. Technical Field

The present invention relates to an electro-optic device, and a method for manufacturing an electro-optic element.

2. Related Art

Electro-optic devices such as a liquid crystal display devices, organic electroluminescence display devices (organic EL display devices), etc., are commonly mounted as a display module on mobile electronic appliances, such as mobile phones and PDAs, etc. In recent years, there are more opportunities to watch high-definition images in these electro-optic devices. Therefore, improvement in the color reproduction capability of electro-optic elements that constitute the electro-optic device has been desired.

As a result, a microcavity structure, in which the color reproduction capabilities of these electro-optic elements are improved, is suggested. Mitsuhiro Kashiwabara, et al. “Advanced AM-OLED Display Based on White Emitter with Microcavity Structure” SID 04 DIGEST page 1017-1019, 2004 is an example of related art. In the microcavity structure in the above-referenced example, a so-called top emission structure is composed of a positive electrode that has a reflection layer, a semi-transmissive negative electrode, and an organic EL layer arranged between them. This microcavity structure functions as a kind of an optical filter that selects a wavelength that corresponds to one of the colors red (R), green (G), and blue (B), from the wavelength of light emitted from the organic EL layer.

More specifically, light (reflection light), which is emitted from the organic EL layer and is reflected at the positive electrode, and light (transmitted light), which is similarly emitted from the organic EL layer and transmits through the negative electrode, undergo multiple interference, and light with a prescribed wavelength is emitted. Further, by changing the optical distance between the positive electrode and the negative electrode, the interference of the reflection light and the transmitted light changes, thereby allowing the selective output of light with a different wavelength for each of the colors red, green, and blue. Due to this mechanism, in this microcavity structure, the optical distance changes according to each color by arranging, in between the positive electrode and the negative electrode, Indium Tin Oxide (ITO) with different film thicknesses for red, green, and blue, in order to emit light with a wavelength corresponding to each color. Consequently, a light emission with high color purity can be obtained, achieving a vivid color reproduction capability.

However, since this microcavity structure has been commonly manufactured by a photolithography method, a plurality of photolithography processes have been necessary in order to form the ITO films in different film thicknesses for red, green, and blue. Consequently, the number of manufacturing processes for forming the electro-optic device have increased, impairing its productivity.

### SUMMARY

The advantage of the invention is to provide a method for manufacturing an electro-optic element with improved productivity, while also improving the color reproduction capability, as well as to provide an electro-optic device with such characteristics.

According to an aspect of the invention, a method for manufacturing an electro-optic element includes: forming a first electrode and a second electrode on a luminescent layer deposited on a substrate; applying current to the luminescent layer through the first electrode and the second electrode; thereby the luminescent layer emits light; wherein a functional liquid including a conductive material is discharged on the side of the luminescent layer of the first electrode by a droplet discharge device, in order to form a conductive spacer with optical transparency.

According to the above aspect of the invention, the conductive spacer with optical transparency is formed, by discharging the functional liquid including the conductive material, on the side of the luminescent layer of the first electrode by the droplet discharge device. As a result, merely discharging the functional liquid with the droplet discharge device allows the easy formation of the conductive spacer with optical transparency. Consequently, the number of manufacturing processes can be reduced, compared, for instance, to the case of forming the conductive spacer that has optical transparency with the photolithography processes; hence, the productivity can be increased.

In this case, in the method of manufacturing the electro-optic element, the second electrode may be an electrode with optical transparency; and the first electrode may be an electrode with light reflexivity, and the functional liquid including the conductive material may be discharged on the side of the luminescent layer of the first electrode by the droplet discharge device, in order to form the conductive spacer with optical transparency.

According to the above case in the above aspect of the invention, the second electrode is the electrode with optical transparency; and the first electrode is the electrode with light reflexivity, and the functional liquid including the conductive material is discharged on the side of the luminescent layer of the first electrode by the droplet discharge device, in order to form the conductive spacer with optical transparency. As a result, the conductive spacer with optical transparency can, for instance, be formed in the electro-optic element with the top emission structure, by discharging the functional liquid with the droplet discharge device. Consequently, the productivity can be improved while keeping the element's high brightness.

In this case, in the method of manufacturing the electro-optic element, the second electrode may be the electrode with optical transparency; the first electrode may be the electrode with optical transparency, and the functional liquid including the conductive material may be discharged on the side of the luminescent layer of the first electrode by the droplet discharge device, in order to form the conductive spacer with optical transparency; and a reflection layer may be formed between the first electrode and the substrate.

According to the above case in the above aspect of the invention, the second electrode is the electrode with optical transparency; the first electrode is the electrode with optical transparency, and the functional liquid including the conductive material is discharged on the side of the luminescent layer of the first electrode by the droplet discharge device, in order to form the conductive spacer with optical transparency; and a reflection layer is formed between the first electrode and the substrate. As a result, the conductive spacer with optical transparency can, for instance, be formed in the electro-optic element with the top emission structure, in which the first and the second electrodes both have optical transparency, by the functional liquid discharged from the droplet discharge device. Consequently, the productivity can be improved while keeping the element's high brightness.

In this case, in the method of manufacturing the electro-optic element, the substrate may be a transparent substrate; the second electrode may be the electrode with light reflexivity; and the first electrode may be the electrode with optical transparency, and the functional liquid including the conductive material may be discharged on the side of the luminescent layer of the first electrode by a droplet discharge device, in order to form a conductive spacer with optical transparency.

According to the above case in the above aspect of the invention, the substrate is the transparent substrate; the second electrode is the electrode with light reflexivity; and the first electrode is the electrode with optical transparency, and the functional liquid including the conductive material is discharged on the side of the luminescent layer of the first electrode by a droplet discharge device, in order to form a conductive spacer with optical transparency. As a result, the conductive spacer with optical transparency can, for instance, be formed in the electro-optic element with the bottom emission structure, by discharging the functional liquid with the droplet discharge device. Consequently, the productivity can be improved.

In this case, in the method of manufacturing the electro-optic element, the substrate may be the transparent substrate; the second electrode may be the electrode with optical transparency; the first electrode is the electrode with optical transparency, and the functional liquid including the conductive material may be discharged on the side of the luminescent layer of the first electrode by the droplet discharge device, in order to form the conductive spacer with optical transparency; and the reflection layer may be formed at the opposite side of the luminescent layer of the second electrode.

According to the above case in the above aspect of the invention, the substrate is the transparent substrate; the second electrode is the electrode with optical transparency; the first electrode is the electrode with optical transparency, and the functional liquid including the conductive material is discharged on the side of the luminescent layer of the first electrode by the droplet discharge device, in order to form the conductive spacer with optical transparency; and the reflection layer is formed at the opposite side of the luminescent layer of the second electrode. As a result, the conductive spacer with optical transparency can, for instance, be formed in the electro-optic element with the bottom emission structure, in which the first and the second electrodes both have optical transparency, by the functional liquid discharged from the droplet discharge device. Consequently, the productivity can be improved.

In this case, in the method of manufacturing the electro-optic element, the luminescent layer may be formed with an organic material, and the electro-optic element may be provided with an organic electroluminescence element.

According to the above case in the above aspect of the invention, the productivity of the organic electroluminescence element can be improved.

In this case, in the method of manufacturing the electro-optic element, the luminescent layer is formed with the organic material that emits a white light.

According to the above case in the above aspect of the invention, the productivity of the electro-optic element, in which the luminescent layer is formed with the organic material that emits a white light, can be improved.

In this case, in the method of manufacturing the electro-optic element, the discharge quantity of the functional liquid, which includes the conductive material, and is discharged from the droplet discharge device, may be equivalent to the discharge quantity necessary for the conductive spacer with optical transparency to have a film thickness that corresponds with a light wave length output from the electro-optic element.

According to the above case in the above aspect of the invention, the discharge quantity of the functional liquid, which includes the conductive material and is discharged from the droplet discharge device, is equivalent to the discharge quantity necessary for the conductive spacer with optical transparency to have a film thickness that corresponds with a light wave length output from the electro-optic element. As a result, by only controlling the discharge quantity of the functional liquid discharged from the droplet discharge device, the conductive spacers that have optical transparency with different film thicknesses according to the wavelength of the light emitted by the electro-optic element, are formed easily. Consequently, the number of manufacturing processes can be reduced, compared, for instance, to the case of forming the conductive spacers, which have optical transparency and different thicknesses, with the use of the plurality of photolithography processes; hence, the productivity can be increased, while also improving the color reproduction capability.

According to another aspect of the invention, an electro-optic device is provided with the electro-optic element manufactured in the above-mentioned method for manufacturing the electro-optic element.

In the above aspect of the invention, the productivity of the electro-optic device provided with the aforementioned electro-optic element can be improved.

### BRIEF DESCRIPTION OF THE DRAWINGS

The invention will be described with reference to the accompanying drawings, wherein like numbers reference like elements.

FIG. 1 is a conceptual top view illustration showing an organic electroluminescence (EL) display module in an embodiment, into which the invention is embodied.

Similarly, FIG. 2 is a conceptual sectional illustration showing a sub pixel in the embodiment.

Similarly, FIG. 3 is a conceptual sectional illustration showing an organic EL element in the embodiment.

Similarly, FIG. 4 is an explanatory illustration describing a light emission from the sub pixel in the embodiment.

Similarly, FIG. 5 is a conceptual orthogonal sectional illustration showing a droplet discharge device in the embodiment.

FIG. 6 is a conceptual sectional illustration showing an organic EL element with a bottom emission structure in another example of the embodiment.

FIG. 7 is a conceptual sectional illustration showing an organic EL element with a multi-photon structure in another example of the embodiment.

### DESCRIPTION OF EXEMPLARY EMBODIMENTS

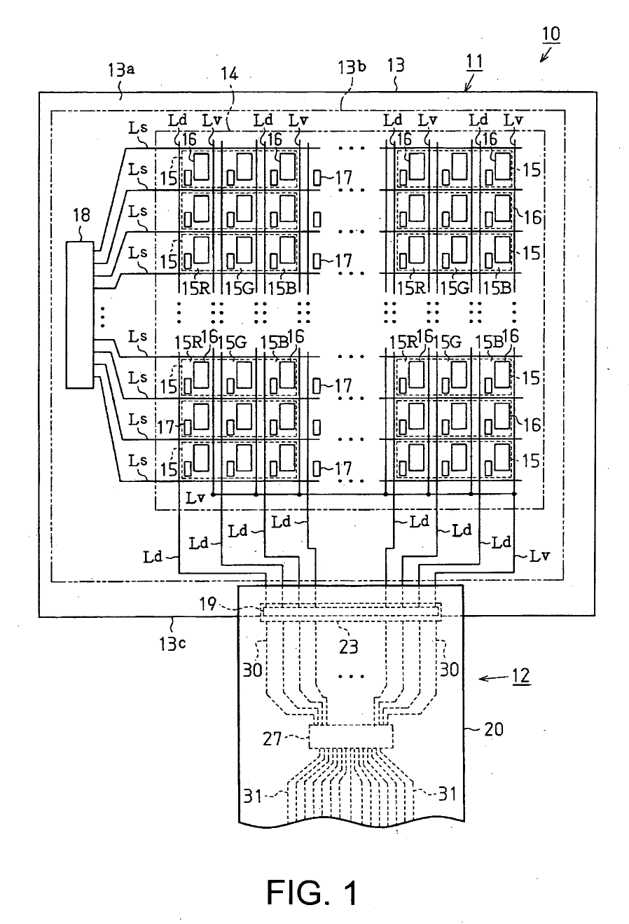

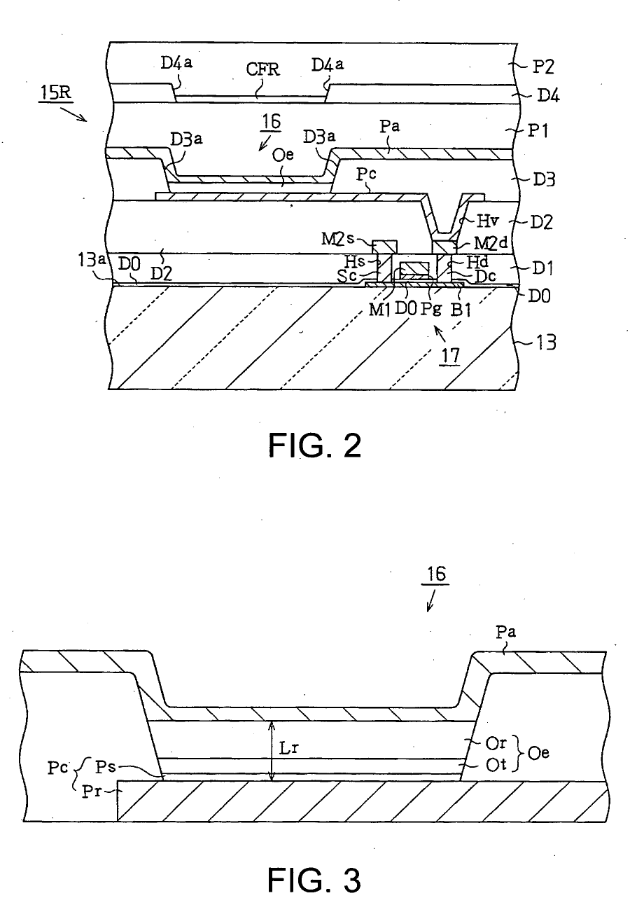

Hereafter, an embodiment, into which the present invention is embodied, is described side by side with FIGS. 1 through 5. FIG. 1 exhibits a conceptual top view illustration of an organic electroluminescence display module 10 (organic EL display module) as a display module.

As shown in FIG. 1, the organic EL display module 10 includes an organic electroluminescence display (organic EL display) 11 as an electro-optic device, and, in the lower side in the figure of the organic EL display 11, a flexible substrate 12 is connected.

The organic EL display 11 is a top emission display in the above-referenced embodiment, and is provided with a glass substrate 13 as a placoid substrate. In approximately the center of the surface of the glass substrate 13 (a pixel forming surface 13a), a quadrangular display area 14 is formed. Within the display area 14, a plurality of data lines Ld that are extended in the top-down direction of FIG. 1 (in the direction of column), and a plurality of power source lines Lv installed along with the data lines Ld, are arrayed in a given interval. In the direction orthogonal to the data lines Ld (in the direction of row), a plurality of scanning lines Ls that is extended in the direction of row is arrayed in a given interval. At each of the locations where these data lines Ld and scanning lines Ls cross, sub pixels 15R, 15G, and 15B that correspond to red (R), green (G), and blue (B), are formed. That is to say, the sub pixels 15R, 15G, and 15B are connected to the corresponding data lines Ld, power source lines Lv and scanning lines Ls; thereby repeatedly arrayed in a matrix. Further, the sub pixels 15R, 15G, and 15B, which correspond to red, green and blue, make up one set, and constitute a pixel circuit 15, where each set is repeatedly and orderly arrayed on the scanning lines Ls.

The pixel circuit 15 includes: an organic electroluminescence element (organic EL element) 16 as an electro-optic element that emits light by a supply of a drive current; a thin film transistor (TFT) 17 that controls the light emission of the organic EL element 16; and a capacitor element (not shown).

A scanning line driving circuit 18, mounted by the Chip on Glass (COG) method, is formed on the left side of the display area 14, which is one of the sides of the pixel forming surface 13a. The scanning line driving circuit 18 outputs a scanning signal to each of the scanning lines Ls, in order to make a selection out of the sub pixels 15R, 1G, and 15B on the scanning lines Ls. Further, the scanning line driving circuit 18 is connected to a print substrate (not shown), and outputs the scanning signal to a given scanning line Ls in a prescribed timing, based on a control signal output from a control IC (integrated circuit) on the print substrate. Still further, by covering approximately the entire surface of the pixel forming surface 13a with a protection glass substrate 13b (indicated with double dashed line in FIG. 1) the scanning line driving circuit 18 and the display area 14 are protected.

A data line terminal formation unit 19 is formed on the bottom of the display area 14, which is one of the sides of the pixel forming surface 13a. In the data line terminal formation unit 19, a plurality of data line terminals (not shown) corresponding to each of the data lines Ld are formed. Each of the data line terminals is a terminal formed with a copper foil, and the data line terminals are arrayed along the bottom side 13c of the glass substrate 13 with an even pitch, and are electrically connected to the corresponding data lines Ld. Moreover, each of the data line terminals, being exposed from the protection glass substrate 13b, allows each of the data lines Ld to be electrically connected with an external unit.

As shown in FIG. 1, the flexible substrate 12 is connected on the surface of the data line terminal formation unit 19, which is one of the sides of pixel forming surface 13a. A substrate body 20 is provided on the flexible substrate 12. The substrate body 20 is a flexible substrate, formed long in the direction of top-down, and with dielectric polyimide resin. The flexible substrate 12 is installed so that the surface of the substrate body 20 (back surface in FIG. 1) faces the pixel forming surface 13a. An external terminal formation unit 23 is installed on the location facing the data line terminal formation unit 19, which is on the surface of the substrate body 20. In the external terminal formation unit 23, a plurality of connection terminals (not shown) is formed in a pitch width, facing the data line terminals. Moreover, the flexible substrate 12 is electrically connected with the data line terminal that correspond with each connection terminal by a so-called anisotropic conductive film (ACF) method, and is mounted onto the organic EL display 11 (the organic EL display module 10).

Further, a driving-IC-chip 27 is installed below the external terminal formation unit 23. The driving-IC-chip 27 generates and supplies a driving signal as well as a driving voltage in order to make the organic EL element 16 to emit light. The driving-IC-chip 27 is mounted on the substrate body 20 (the flexible substrate 12) by the ACF method.

Further, connection terminals (not shown) formed on the output side (the side of the organic EL display 11) of the driving-IC-chip 27, and the connection terminals formed on the external terminal formation unit 23 are connected by an output wiring 30; thereby the driving-IC-chip 27 is electrically connected with each of the data lines Ld and the power source lines Lv. Still further, connection terminals (not shown) formed on the input side of the driving-IC-chip 27 (lower side in FIG. 1), and the control IC on the print substrate (not shown) are connected by input wirings 31; thereby the driving-IC-chip 27 is electrically connected with the control IC.

Moreover, the driving-IC-chip 27 supplies the driving voltage to the power source lines Lv, based on the control signal output from the control IC, and outputs a data signal to given data lines Ld in a given timing. That is to say, if the driving-IC-chip 27 outputs the data signal to the pixel circuit 15 (sub pixels 15R, 15G, and 15B) selected by the scanning signal, then the organic EL element 16 of the pixel circuit 15 (sub pixels 15R, 15G, and 15B) emits light based on the data signal.

FIG. 2 is a sectional illustration of the sub pixel 15R that corresponds to the color red, one of the sub pixels 15R, 15G, and 15B formed on the glass substrate 13 in the organic EL display 11. The illustration and the description of the other sub pixels 15G and 15B are omitted, since they have similar structures as that of the sub pixel 15R, except for the film thicknesses of a positive electrode Pc (described later). In the embodiment, as shown in FIG. 4, color filters CFR, CFG, and CFB, which correspond to red, green and blue, are arranged, in order to conduct a full color display, on the top surface of the organic EL element 16, which emits white light, and is arranged on each of the sub pixels 15R, 15G, and 15B. FIG. 4 is an explanatory illustration describing a light emission from the pixel circuit 15 (the sub pixels 15R, 15G, and 15B) that corresponds to each color.

As shown in FIG. 2, the TFT 17 is provided with a channel film B1 in its bottom layer. The channel film B1 is an island-shaped p-type polysilicon film, formed on the pixel forming surface 13a, and is provided with an activated n-type regions (source and drain regions) (not shown) on its both sides, in FIG. 2. In other words, the TFT 17 is a so-called polysilicon TFT.

A gate insulation film D0, a gate electrode Pg and a gate wiring Ml are formed in order, from the side of the pixel forming surface 13a, at the central location on the top side of the channel film B1. The gate insulation film D0 is an insulation film such as a silicon oxide film or the like with optical transparency, and is deposited on approximately the entire surface of the pixel forming surface 13a. The gate electrode Pg is a low-resistance metallic film such as tantalum etc., and is formed on approximately the central location of the channel film B1. The gate wiring Ml is a transparent conductive film such as indium tin oxide (ITO) or the like with optical transparency, and electrically connects the gate electrode Pg and the driving-IC-chip 27 (refer to FIG. 1). Moreover, if the driving-IC-chip 27 inputs the data signal to the gate electrode Pg through the gate wiring M1, then the TFT 17 is switched on based on the data signal.

A source contact Sc and a drain contact Dc, which extend upward in FIG. 2, are formed on the source region and the drain region, which are part of the channel film B1. Each of the contacts Sc and Dc are formed with metallic films made of metal silicide or the like, which reduces the contact resistance with the channel film B1. Each of the contacts Sc and Dc, as well as the gate electrode Pg (the gate wiring M1) are individually electrically insulated by a first inter-layer insulation film D1 made of silicon oxide film, etc.

On the contacts Sc and Dc (hereafter also referred to as “source contact Sc” and “drain contact Dc”), a power source line M2s and a positive electrode line M2d made of a low-resistance metallic film such as aluminum etc., are formed respectively. The power source line M2s electrically connects the source contact Sc to a drive power source (not shown). The positive electrode line M2d electrically connects the drain contact Dc to the organic EL element 16. The power source line M2s and the positive electrode line M2d are individually electrically insulated by a planarization film D2 made of dielectric material such as silicon dioxide film etc. Moreover, by forming the planarization film D2, the organic EL element 16 formed on the planarization film D2 can be planarized. When the TFT 17 is switched on, based on the data signal, a drive current is supplied from the power source line M2s (drive power source) to the positive electrode line M2d (the organic EL element 16).

As shown in FIG. 2, on the planarization film D2, the organic EL element 16 is formed. In the bottom layer of the organic EL element 16, the positive electrode Pc (equivalent to “first electrode” in claim 1 and claim 2) is formed.

The positive electrode Pc has, as shown in FIG. 3, a deposited structure composed of a reflection layer Pr and a spacer Ps that is deposited thereon as a conductive spacer with optical transparency. Here, FIG. 3 is a sectional illustration of the organic EL element 16. The reflection layer Pr is formed, in the embodiment, with a metallic material, for instance, chromium (Cr), etc.

The spacer Ps is, in the embodiment, a transparent conductive film with optical transparency, for instance an ITO etc., and is formed in a film thickness of at least 10 nm. The spacer Ps has, in the embodiment, a different film thickness corresponding to each color, and is formed, as shown in FIG. 4, to grow thicker in the following order. A spacer Psb of the sub pixel 15B that corresponds to the color blue, a spacer Psg of the sub pixel 15G that corresponds to the color green. and a spacer Psr of the sub pixel 15R that corresponds to the color red.

As shown in FIG. 2, the positive electrode Pc has one of its end connected to the positive electrode line M2d. On the top side of the positive electrode Pc at its outer boundary, a third inter layer insulation film D3 is deposited so as to surround the positive electrode Pc. The third inter layer insulation film D3 is formed with a resin film provided with photosensitive polyimide, acryl, etc., and electrically insulates the positive electrode Pc of each organic EL element 16. Further, the third inter layer insulation film D3 opens the top side of the positive electrode Pc, and forms the isolation wall D3a made of its inner circumference surface.

An organic electroluminescence layer (organic EL layer) Oe made of an organic material is formed in the inner side of the isolation wall D3a on the top side of the positive electrode Pc. The organic EL layer Oe is, as shown in FIG. 3, an organic chemical compound layer composed of two layers, a hole transport layer Ot and a luminescent layer Or. Here, in the embodiment, the luminescent layer Or is a luminescent layer that emits white light. A negative electrode Pa (equivalent to “second electrode” in claim 1 and claim 2), which is made of a metallic film such as magnesium (Mg) etc., is formed on top of the organic EL layer Oe, at the interface with the organic EL layer Oe and with the transparent conductive film that has optical transparency, such as ITO etc. As shown in FIG. 2, the negative electrode Pa is formed so as to cover the entire surface of the pixel forming surface 13a, and is shared by each pixel circuit 15; thereby supplying a potential common to each organic EL element 16.

The organic EL element 16 is, in other words, an organic electroluminescence element (organic EL element) formed with the positive electrode Pc (the reflection layer Pr and the spacer Ps), the organic EL layer Oe, and the negative electrode Pa.

A sealing portion P1 is formed with a coating material such as resin etc., in order to prevent oxidation of various metallic films and the organic EL layer Oe, on the top side of the negative electrode Pa. A forth inter layer insulation film D4 is formed on the sealing portion P1. The forth inter layer insulation film D4 is formed with a resin films provided with photosensitive polyimide, acryl, or the like. Further, the forth inter layer insulation film D4 opens the top side of the organic EL layer Oe, and forms the isolation wall D4a made of its inner circumference surface. Still further, the color filter CFR is formed at the inner side of the isolation wall D4a on the top side of the sealing portion P1. The color filter CFR is formed with pigments that corresponds with the color red. Moreover, a sealing portion P2 is formed with a coating material such as resin etc., in order to prevent oxidation of the color filter CFR, on the top side of the color filter CFR.

Thereafter, when a drive current corresponding to the data signal is supplied to the positive electrode line M2d, the organic EL layer Oe emits light in brightness corresponding to the drive current. Here, the light emitted from the organic EL layer Oe toward the side of the negative electrode Pa (upward in FIG. 2), hereafter transmitted light, transmits through the negative electrode Pa, the sealing portion P1, the color filter CFR, and the sealing portion P2. Further, the light emitted from the organic EL layer Oe toward the side of the positive electrode Pc (downward in FIG. 2), hereafter reflected light, is reflected by the reflection layer Pr of the positive electrode Pc, and transmits through the space Ps, the organic EL layer Oe, the negative electrode Pa, the sealing portion P1, the color filter CFR, and the sealing portion P2. Then, the a light which is a result of interference between the transmitted light and the reflected light is output to the side of the protection glass substrate 13b.

A wavelength λ of the spectrum of the output light depends on the optical distances Lr, Lg, and Lb (refer to FIG. 4), which represent a distance between the reflection layer Pr and the negative electrode Pa. Therefore, by changing the optical distance Lr, Lg, and Lb in accordance with each of the colors (red, green and blue), it is possible to obtain the wavelength λ of light that corresponds to each color. In the embodiment, the optical distances Lr, Lg, and Lb are changed by forming spacers Ps (Psr, Psg, and Psb) with different thicknesses that correspond to each color; thereby obtaining the wavelength λ of light that corresponds to each color.

That is to say, as shown in FIG. 4, the spacer Psr is formed to have the thickest film thickness so that the optical distance Lr becomes the longest in the sub pixel 15R that corresponds to the color red, the wavelength of which is the longest. On the other hand, the spacer Psb is formed to have the thinnest film thickness so that the optical distance Lb becomes the shortest in the sub pixel 15B that corresponds to the color blue of which its wavelength is the shortest. As for the sub pixel 15G that corresponds to the color green, the wavelength of which is within the range of the former two colors, the spacer Psg is formed so that the optical distance Lg will be within the range of the two.

Hereafter, the method for manufacturing the pixel circuit 15 (sub pixels 15R, 15G, and 15R) will be described.

Initially, an amorphous silicon film is deposited to the entire surface of the pixel forming surface 13a by the Chemical Vapor Deposition (CVD) method which uses disilane etc., as a raw material. Thereafter, an ultraviolet light is radiated on the amorphous silicon film by an excimer laser, etc., and a crystallized polysilicon film is formed over the entire surface of the pixel forming surface 13a. Sequentially, a patterning is performed on the polysilicon film by a photolithography method and an etching method; thereby forming the channel film B1.

After forming the channel film B1, the gate insulation film D0 is formed by depositing the silicon oxide film etc., on the entire top surface of the channel film B1 and the pixel forming surface 13a, by the CVD method which uses silane etc., as a raw material. After forming the gate insulation film D0, a low-resistance metallic film with tantalum etc., is deposited on the entire top surface of the gate insulation film D0 by a sputter method etc., and a patterning is performed on the low-resistance metallic film; thereby forming the gate electrode Pg on the gate insulation film D0. After forming the gate electrode Pg, the n-type regions (source and drain regions) is formed on the channel film B1 by ion doping method using the gate electrode Pg as a mask. Sequentially, the transparent conductive film with optical transparency, such as ITO etc., is deposited on the entire top surface of the gate electrode Pg and on the gate insulation film D0 by the sputter method etc., and the patterning is performed on the transparent conductive film; thereby forming the gate wiring M1 on the gate electrode Pg.

After forming the gate wiring M1, a silicon oxide film etc., is deposited on the entire top surface of the gate wiring M1 and on the gate insulation film D0 by the CVD method, which uses tetraethoxysilane (TEOS) etc., as a raw material; thereby forming the first inter layer insulation film D1. After forming the first inter layer insulation film D1, a pair of circular holes (contact holes Hd and Hs), which open the area (upward in FIG. 2) between the source area and the top of the first inter layer insulation film D1 (as well as between the drain area and the top of the first inter layer insulation film D1), by the photolithography method or the etching method, etc., is formed. After forming the contact holes Hd and Hs, a metallic film is deposited to the entire top surface of the first inter layer insulation film D1, while burying the contact holes Hd and Hs with a metal silicide etc., by the sputter method or the like. Thereafter, the metallic film, except within the area of the contact holes Hd and Hs, is removed by the etching method, etc., and the source contact Sc and the drain contact Dc are formed.

After forming the contacts Sc and Dc, a metallic film made of aluminum etc., is deposited on the entire top surface of the first inter layer insulation film D1 and the contacts Sc and Dc by the sputter method. Then, the patterning is performed on the metallic film; thereby forming the power source line M2s and the positive electrode line M2d that connect to each of the contacts Sc and Dc. Thereafter, a silicon oxide film or the like is deposited on the entire top surface of the power source line M2s, the positive electrode line M2d, and the first inter layer insulation film D1 by the CVD method, which uses tetraethoxysilane (TEOS) etc., as a raw material; thereby forming the planarization film D2. Sequentially, a circular hole (via hole Hv), which opens the area (upward in FIG. 2) between the part of the positive electrode line M2d and the top of the planarization film D2, by the photolithography method or the etching method, etc., is formed. After forming the via hole Hv, a m metallic film made of chromium or the like is deposited to the entire top surface of the planarization film D2, while burying the via hole Hv by the sputter method, etc. Thereafter, a patterning is performed on the metallic film, thereby forming the positive electrode Pc (reflection layer Pr) that connects to the positive electrode line M2d through the via hole Hv.

After forming the reflection layer Pr, a mask made of a resist or the like is formed on the reflection layer Pr, and a resin film provided with photosensitive polyimide, acryl resin etc., is deposited on the entire top surface of the reflection layer Pr and the planarization film D2. Thereafter, the resist etc. are stripped off, and the third inter layer insulation film D3, provided with the isolation wall D3a is formed.

After forming the isolation wall D3a, the positive electrode Pc (the spacer Ps) is subsequently formed within the isolation wall D3a. FIG. 5 is an explanatory illustration describing the method of forming the spacer Ps. Initially, the structure of a droplet discharge device for forming the spacer Ps is described.

As shown in FIG. 5, a droplet discharge head 44 that constitutes the droplet discharge device is arranged on the glass substrate 13. A nozzle plate 45 is provided on the droplet discharge head 44. Multiple nozzles N, which discharge plutonium (Pu) (ITO forming material) as a functional liquid containing a conductive material, are formed along the vertical direction Z, on the surface of the side of the glass substrate 13, which is one of the sides of the nozzle plate 45. Moreover, the glass substrate 13 is positioned, so that its pixel forming surface 13a is parallel to a nozzle forming surface 45a, and that the central location of each isolation wall D3a faces the central location of each of the nozzles N.

Supply chambers 46R, 46G, and 46B, which are connected to the container tank (not shown) and allow supplying of the ITO forming material Pu into the nozzles N, are formed on each of the nozzles N, corresponding to the colors red, green, and blue. A vibration plate 47, which expands or shrinks the volume of the supply chambers 46R, 46G, and 46B, by reciprocating along the vertical direction Z, is installed on each of the supply chambers 46R, 46G, and 46B. Piezoelectric elements 48R, 48G, and 48B, which vibrate the vibration plate 47 by expanding and contracting themselves along the vertical direction Z, are installed corresponding to the colors red, green, and blue, at the locations, which face each of the supply chambers 46R, 46G, and 46B on the vibration plate 47.

Hereafter, the method of forming the spacer Ps by the above-mentioned droplet discharge device will be described.

Initially, a driving signal for forming the spacer Ps is input to the droplet discharge head 44. Then, the piezoelectric elements 48R, 48G, and 48B each expand and contract themselves based on the drive signal, and the volumes of the supply chambers 46R, 46G, and 46B expand and shrink individually. Here, when the supply chambers 46R, 46G, and 46B shrink, the ITO forming material Pu, the amount of which is equivalent to the volume that shrunk, is discharged from each of the nozzles N as a droplet Ds to the corresponding space within the isolation wall D3a. Sequentially, when the supply chambers 46R, 46G, and 46B expand, the ITO forming material Pu, the amount of which is equivalent to the volume that expanded, is supplied from the container tank (not shown) to the supply chambers 46R, 46G, and 46B.

That is to say, the droplet discharge head 44 discharges a given volume of ITO forming material Pu, the quantity of which is corresponding to the different film thickness for each colors, to a space within the isolation wall D3a, by expanding and shrinking each of the supply chambers 46R, 46G, and 46B. Then, after leaving the discharged ITO forming material Pu for a prescribed period of time in order to dry it, the glass substrate 13 is carried into a firing chamber (not shown) and undergoes firing; hence the conductive spacers Ps (Psr, Psg, and Psb), with a different thickness for each color, is formed.

As a result, the plurality of photolithographic processes for changing the film thickness per color, as is done in the case of forming the spacers Ps (Psr, Psg, Psb) by the photolithography method, becomes unnecessary, thereby allowing the reduction of the manufacturing processes. Furthermore, there is no need to remove the ITO that was deposited on the portions excluding the spacers Ps (Psr, Psg, and Psb), by photolithography method or etching, thereby allowing the reduction of the amount of usage of ITO in the manufacturing process.

After forming the spacer Ps, a constituent material of the hole transport layer Ot is discharged onto the spacer Ps that is surrounded by the isolation wall D3a using an inkjet method etc., and the constituent material is dried and solidified; thereby forming the hole transport layer Ot. Further, a constituent material of the luminescent layer Or is discharged on the hole transport layer Ot by the inkjet method etc., and the constituent material is dried and solidified; thereby forming the luminescent layer Or. Consequently, the organic EL layer Oe provided with the hole transport layer Ot and the luminescent layer Or is formed.

After forming the organic EL layer Oe, the negative electrode Pa is formed by depositing a metallic film made of aluminum etc., on the entire top surface of the organic EL layer Oe and the third inter layer insulation film D3 with sputter method, etc. After forming the negative electrode Pa, the sealing portion P1 is formed by depositing a coating material such as resin etc., on the entire surface of the negative electrode Pa by CVD method or the like. Sequentially, a mask made of a resist or the like is formed on the sealing portion P1, and a resin film provided with photosensitive polyimide, acryl, etc., is deposited on the entire top surface of the sealing portion P1. Then, the resist etc. are stripped off, and the forth inter layer insulation film D4, provided with the isolation wall D4a is formed. Thereafter, the color filter CFR (or CFG, CFB) is formed within the isolation wall D4a and is sealed with the sealing portion P2; thereby forming the pixel circuit 15 (sub pixels 15R, 15G, and 15B) provided with the organic EL element 16 on the pixel forming surface 13a.

According to the above-referenced embodiment, the following effects can be attained.

1. According to the embodiment, the organic EL element 16 is composed by stacking the positive electrode Pc (the reflection layer Pr, the spacer Ps), the organic EL layer Oe and the negative electrode Pa. Moreover, according to each color (red, green, and blue), the film thickness of the spacer Ps differs. As a result, a light that corresponds to the colors red, green, and blue can be extracted in a high precision from the organic EL element 16. Consequently, the color reproduction capability of the organic EL display 11 that uses the organic EL element can be improved.

2. According to the embodiment, the spacers Psr, Psg, and Psb, which have different film thicknesses according to the colors red, green, and blue, are formed by the droplet discharge device (droplet discharge head 44). As a result, the spacers Psr, Psg, and Psb can be easily formed by only controlling the discharge quantity of the ITO forming material Pu. Consequently, the number of manufacturing processes can be reduced, compared, for instance, to the case of forming the spacers Psr, Psg, and Psb, which have different film thicknesses, with the use of a plurality of photolithographic processes.

3. According to the embodiment, the spacers Psr, Psg, and Psb, which have different film thicknesses according to the colors red, green, and blue, are formed by the droplet discharge device (droplet discharge head 44). Therefore, it is possible to discharge the functional liquid, only to a portion where the spacers Psr, Psg, and Psb will be formed (a location corresponding to the organic EL element 16). Consequently, since there is no need to etch off, for instance, the ITO deposited on the portions except on the organic EL element 16, it is possible to reduce the amount of material used for manufacturing.

The above-referenced embodiment can be modified as the followings.

The glass substrate 13 is transparent in the above-referenced embodiment. However, it may also be a non-transparent substrate made of stainless-steel, etc.

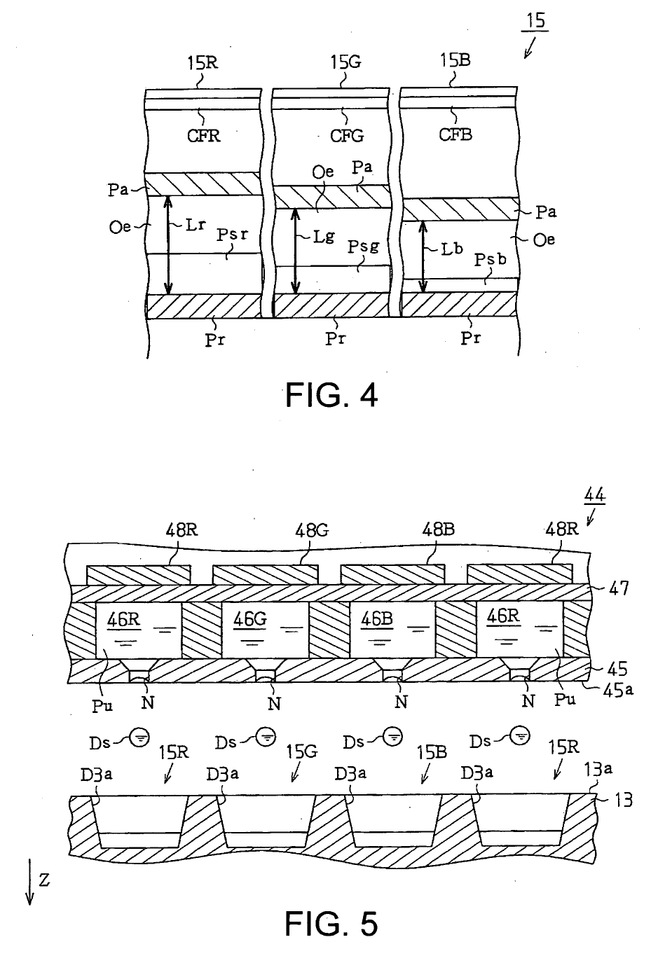

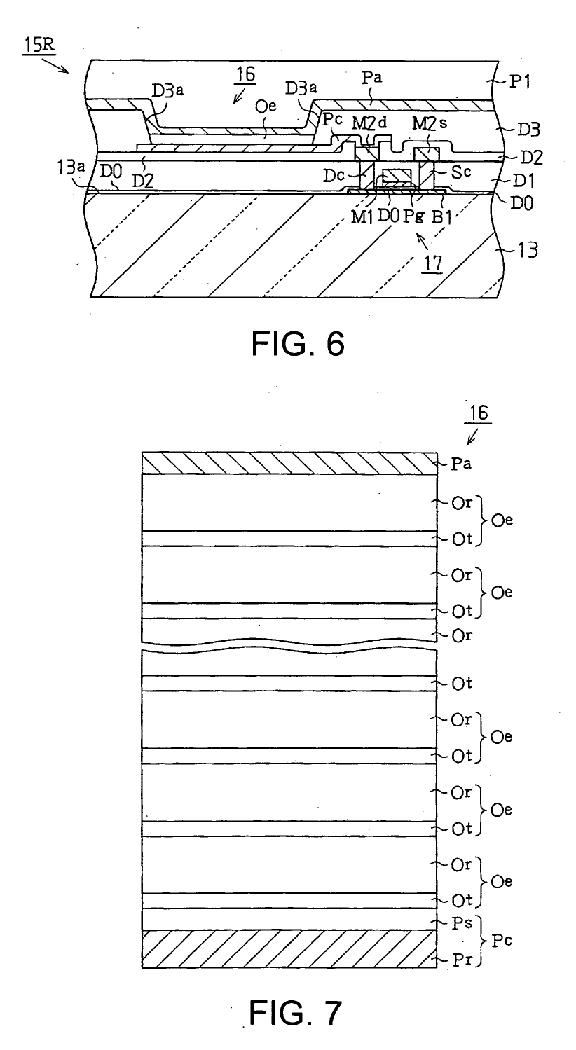

The organic EL element 16 is embodied as the top emission structure in the above-referenced embodiment. However, it may also be a bottom emission structure as shown in FIG. 6. FIG. 6 is a sectional illustration of the sub pixel 15R embodied in the bottom emission structure, without indicating the color filter CFR. In this case, the substrate is transparent; the positive electrode Pc (equivalent to “first electrode” in claim 1 and claim 4) is formed with ITO; and the film thickness of the positive electrode Pc is made to differ, per pixel circuit 15 (the sub pixels 15R, 15G, and 15B) that correspond to each color, by changing the discharge quantity of the functional liquid discharged from the droplet discharge device. Moreover, the optical distances Lr, Lg, and Lb that indicate the distance between the negative electrode Pa (equivalent to “second electrode” in claim 1 and claim 4) and the positive electrode Pc, is made to differ.

Further, in the bottom emission structure, the negative electrode Pa may be provided with an electrode with optical transparency, and the reflection layer Pr (equivalent to “light reflection layer” in claim 5), which is made of Cr or the like may be formed on the opposite side of the luminescent layer Or of the negative electrode Pa.

The positive electrode Pc is provided with the reflection layer Pr and the spacer Ps in the above-referenced embodiment. However, the positive electrode Pc may be provided with the spacer Ps, whereas the reflection layer Pr (equivalent to “light reflection layer” in claim 3) may be formed between the planarization film D2 and the positive electrode Pc (equivalent to “first electrode” in claim 1 and claim 3).

The organic EL element 16 is embodied as the top emission structure in the above-referenced embodiment. However, it may also be a multi-photon structure as shown in FIG. 7, where the several organic EL elements 16 of the top emission structure are deposited. FIG. 7 is a magnified illustration of the organic EL element 16. In this case as well, the film thickness of the spacer Ps is made to differ, per the sub pixels 15R, 15G, and 15B that correspond to each color, by changing the discharge quantity of the functional liquid discharged from the droplet discharge device; thereby making the optical distances Lr, Lg, and Lb, which indicate the distance between the negative electrode Pa and the positive electrode Pc, differ. Moreover, the multi-photon structure, in other words, layering of the organic EL layers Oe (the luminescent layers Or) increases the number of generated photons, allowing the equivalent of 100% or more internal quantum efficiency. Hence, a long-lasting organic EL element 16 with a high brightness can be manufactured in a smaller number of manufacturing processes, while improving the color reproduction capability.

In the above-referenced embodiment, in order to conduct a full color display, the pixel circuit 15 is structured in a way that the color filters CFR, CFG, and CFB are arranged on the top surface of the organic EL element 16, which is provided with the luminescent layer Or that emits a white light. However, a full color display may also be conducted, not by providing the color filters CFR, CFG, and CFB, but by using three organic materials for red, green, and blue as the luminescent layers Or of the sub pixels 15R, 15G, and 15B.

In the above-referenced embodiment, in order to conduct a full color display, the organic EL element 16 is structured in a way that the color filters CFR, CFG, and CFB are arranged on the top surface of the organic EL element 16, which is provided with the luminescent layer Or that emits a white light. However, a full color display may also be conducted by arranging a red luminescent film in correspondence to the sub pixel 15R, and a green luminescent film in correspondence to the sub pixel 15G, on the top surface of the organic EL element provided with a luminescent layer that emits a blue light.

In the above-referenced embodiment, the patterning of the spacers Psr, Psg, and Psb of the organic EL elements 16 are conducted by generating the isolation wall D3a. However, instead of generating the isolation wall D3a, liquid-repellent pattern may also be formed in advance on the planarization film D2. Here, the spacers Psr, Psg, and Psb can be formed in a similar manner as that of the above-referenced embodiment, by discharging the ITO forming material Pu on the liquid-repellent pattern, with the droplet discharge device.

In the above-referenced embodiment, the patterning of the spacers Psr, Psg, and Psb of the organic EL elements 16 are conducted by generating the isolation wall D3a. However, instead of generating the isolation wall D3a, hydrophilic pattern may also be formed in advance on the planarization film D2. Here, the spacers Psr, Psg, and Psb can be formed in a similar manner as that of the above-referenced embodiment, by discharging the ITO forming material Pu on the hydrophilic pattern, with the droplet discharge device.

In the above-referenced embodiment, the functional liquid, discharged by the droplet discharge device, is embodied as the ITO forming material Pu. However, not limited to the above-referenced embodiment, any functional liquid that has optical transparency as well as conductivity after firing and solidification, may also be employed.

The ITO was used in the above-referenced embodiment as a transparent electrode material for forming the spacers Psr, Psg, and Psb. However, ITO, IZO (indium zinc oxide), ATO (antimony tin oxide), FTO (fluorine tin oxide), Sn₂O, ZnO₂, CdO, TiO₂, and V₂O₅, or the like may also be used as a transparent electrode material, or translucent material.

Cr is used in the above-referenced embodiment as a material for forming the reflection layer Pr of the organic EL element 16. However, metals such as Ti, Ag, Au, Ni, Al and their alloys may also be used.

In the above-referenced embodiment, the display module is embodied as the organic EL display module 10. However, not limited to the above-referenced embodiment, the display module may also be provided with a liquid crystal display, or with a field-effect display (a field emission display or a surface-conduction electron-emitter display, etc.), which is provided with a flat electron-emitting element, and utilizes the light emission of the luminescent material, caused by the electron emitted from the element.

What is claimed is:

1. A method for manufacturing an electro-optic element comprising:
forming a first electrode and a second electrode on a luminescent layer deposited on a substrate; and
emitting light from the luminescent layer by applying current to the luminescent layer through the first electrode and the second electrode;
wherein a functional liquid including a conductive material is discharged on the side of the luminescent layer of the first electrode by a droplet discharge device, in order to form a conductive spacer with optical transparency.

2. The method for manufacturing the electro-optic element according to claim 1, wherein:
the second electrode is an electrode with optical transparency; and
the first electrode is an electrode with light reflexivity, and the functional liquid including the conductive material is discharged on the side of the luminescent layer of the first electrode by the droplet discharge device, in order to form the conductive spacer with optical transparency.

3. The method for manufacturing the electro-optic element according to claim 1, wherein:
the second electrode is the electrode with optical transparency;
the first electrode is the electrode with optical transparency, and the functional liquid including the conductive material is discharged on the side of the luminescent layer of the first electrode by the droplet discharge device, in order to form the conductive spacer with optical transparency; and
a reflection layer is formed between the first electrode and the substrate.

4. The method for manufacturing the electro-optic element according to claim 1, wherein:
the substrate is a transparent substrate;
the second electrode is the electrode with light reflexivity; and
the first electrode is the electrode with optical transparency, and the functional liquid including the conductive material is discharged on the side of the luminescent layer of the first electrode by a droplet discharge device, in order to form a conductive spacer with optical transparency.

5. The method for manufacturing the electro-optic element according to claim 1, wherein:
the substrate is the transparent substrate;
the second electrode is the electrode with optical transparency;
the first electrode is the electrode with optical transparency, and the functional liquid including the conductive material is discharged on the side of the luminescent layer of the first electrode by the droplet discharge device, in order to form the conductive spacer with optical transparency; and
the reflection layer is formed at the opposite side of the luminescent layer of the second electrode.

6. The method for manufacturing the electro-optic element according to claim 1, wherein:
the luminescent layer is formed with an organic material, and the electro-optic element is provided with an organic electroluminescence element.

7. The method for manufacturing the electro-optic element according to claim 1, wherein:
the luminescent layer is formed with the organic material that emits a white light.

8. The method for manufacturing the electro-optic element according to claim 1, wherein:
the discharge quantity of the functional liquid, which includes the conductive material and is discharged from the droplet discharge device, is equivalent to the discharge quantity necessary for the conductive spacer with optical transparency to have a film thickness that corresponds with a light wave length output from the electro-optic element.

9. An electro-optic device provided with the electro-optic element manufactured in the method for manufacturing the electro-optic element according to claim 1.
